(19) United States
(12) Patent Application Publication
(10) Pub. No.: US 2026/0050160 A1
(43) Pub. Date: Feb. 19, 2026

(54) HEAD-UP DISPLAY DEVICE AND TEMPERATURE CONTROL METHOD OF HEAD-UP DISPLAY DEVICE

(71) Applicant: Coretronic Corporation, Hsin-Chu (TW)

(72) Inventor: Yu-Wei Guo, Hsin-Chu (TW)

(73) Assignee: Coretronic Corporation, Hsin-Chu (TW)

(21) Appl. No.: 19/266,190

(22) Filed: Jul. 11, 2025

(30) Foreign Application Priority Data
Aug. 13, 2024 (CN) 202411105214.5

(51) Int. Cl. G02B 27/01

(52) U.S. Cl. CPC G02B 27/0101

(57) ABSTRACT

A head-up display device and a temperature control method thereof are provided. The head-up display device includes a display unit, a reflective component, at least one temperature sensor, and a processing unit. The display unit provides an image beam. The reflective component is disposed on a transmission path of the image beam and has open and closed states. The temperature sensor is disposed on the reflective component and senses the reflective component to obtain at least one temperature. The processing unit is electrically connected to the display unit, the reflective component, and the temperature sensor and periodically controls the temperature sensor to sense and obtain the temperature of the temperature sensor. When a maximum value of the temperature is greater than a first threshold, the processing unit controls the display unit to reduce an intensity of the image beam and/or to place the reflective component in the closed state.

### CROSS-REFERENCE TO RELATED APPLICATION

This application claims the priority benefit of China application serial no. 202411105214.5 filed on Aug. 13, 2024. The entirety of the above-mentioned patent application is hereby incorporated by reference herein and made a part of this specification.

### BACKGROUND OF THE INVENTION

### Field of the Invention

The invention relates to an electronic device and a temperature control method, and in particular to a head-up display device and a temperature control method of a head-up display device.

### Description of Related Art

The development of display technology in recent years has led to the widespread use of various head-up display devices in daily life, wherein head-up display devices are often used in aircraft, vehicles, shop windows, etc. Taking a vehicle head-up display device as an example, the inner surface of the windshield is used as an optical combiner to provide information to the driver. When driving, the driver may see the information provided by the in-vehicle information system without looking down at the instrument panel or the navigator.

Since most head-up display devices are used in outdoor areas, sunlight may be concentrated on the internal display unit via the imaging lens group of the head-up display device. This may cause the temperature of the display unit to exceed the (allowable) upper limit that the display unit may withstand, resulting in damage to the display unit and reducing the service life of the head-up display device.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY OF THE INVENTION

The invention provides a head-up display device and a temperature control method of a head-up display device that may prevent the head-up display device from being damaged by exposure to ambient light.

In order to achieve one, a portion, or all of the above objects or other objects, an embodiment of the invention provides a head-up display device. The head-up display device includes a display unit, a reflective component, at least one temperature sensor, and a processing unit. The display unit is configured to provide an image beam. The reflective component is disposed on a transmission path of the image beam and has an open state and a closed state. The at least one temperature sensor is disposed on the reflective component and configured to sense the reflective component to obtain at least one temperature. The processing unit is electrically connected to the display unit, the reflective component, and the at least one temperature sensor and configured to periodically control the at least one temperature sensor to sense and obtain the at least one temperature of the at least one temperature sensor. When a maximum value of the at least one temperature is greater than a first threshold, the processing unit is configured to control the display unit to reduce an intensity of the image beam and/or to place the reflective component in the closed state. When the maximum value of the at least one temperature is less than or equal to the first threshold, the processing unit is configured to control the display unit to increase the intensity of the image beam and/or to place the reflective component in the open state.

To achieve one, a portion, or all of the above objects or other objects, an embodiment of the invention provides a temperature control method of a head-up display device, wherein the head-up display device includes a display unit, a reflective component, and a processing unit, wherein the display unit is configured to provide an image beam, and the temperature control method of the head-up display device includes the following steps: controlling at least one temperature sensor disposed on the reflective component via the processing unit to periodically sense a temperature of the reflective component to obtain at least one temperature of the at least one temperature sensor; and determining whether a maximum value of the at least one temperature of the at least one temperature sensor is greater than a first threshold via the processing unit, wherein, when the maximum value of the at least one temperature is greater than the first threshold, the display unit is controlled to reduce an intensity of the image beam and/or to place the reflective component in the closed state, and when the maximum value of the at least one temperature is less than or equal to the first threshold, the display unit is controlled to increase the intensity of the image beam and/or to place the reflective component in the open state.

Based on the above, in the head-up display device and the temperature control method of the head-up display device of an embodiment of the invention, the head-up display device may effectively detect whether the ambient light is incident on the display unit via the control of the display unit, the reflective component, and the at least one temperature sensor by the processing unit and accordingly adjust the intensity of the image beam and/or adjust the state of the reflective component to prevent the head-up display device from being damaged due to excessive exposure to ambient light.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic architectural diagram of a head-up display device of an embodiment of the invention.

FIG. 2 is a structural diagram of the head-up display device of FIG. 1.

FIG. 3A to FIG. 3C and FIG. 4A to FIG. 4C are respectively schematic top views of the corresponding positions of the light spot distribution formed by the reflective component and the display unit of FIG. 2 after being exposed to ambient light.

FIG. 5 is a schematic flowchart of a temperature control method of a head-up display device of an embodiment of the invention.

FIG. 6A and FIG. 6B are schematic optical path diagrams of another head-up display device of FIG. 1 when exposed to ambient light.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

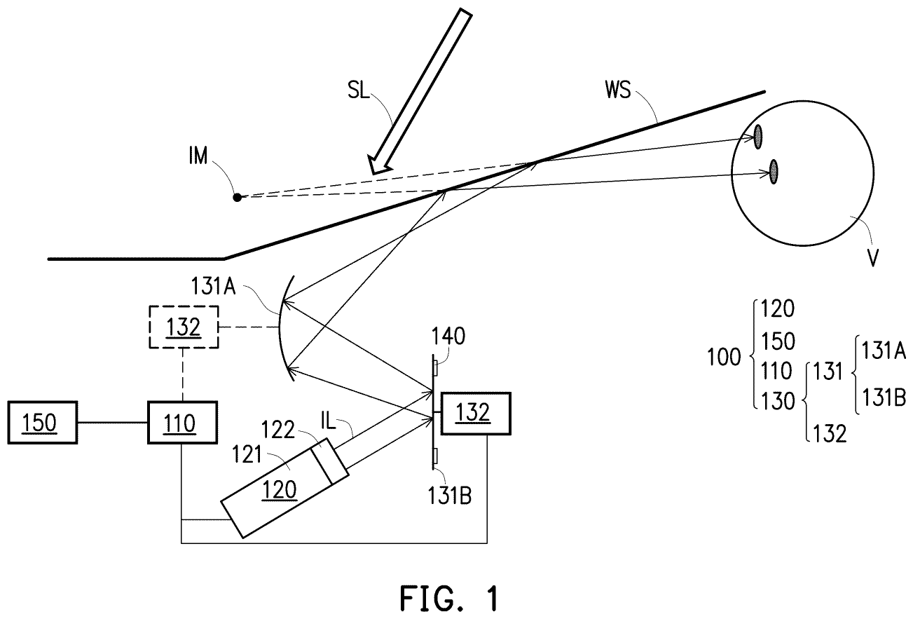

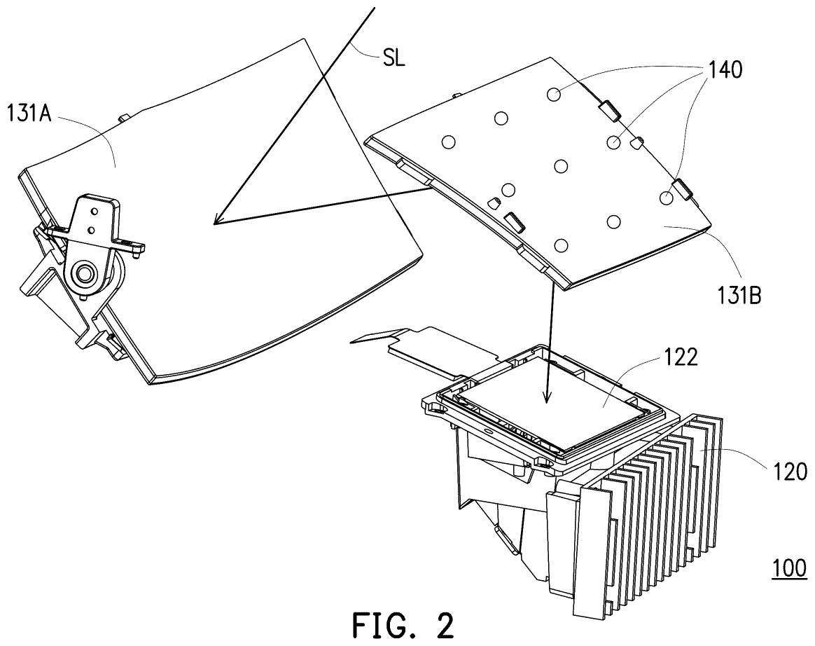

FIG. 1 is a schematic architectural diagram of a head-up display device of an embodiment of the invention. FIG. 2 is a structural diagram of the head-up display device of FIG. 1. Please refer to FIG. 1, in the present embodiment, a head-up display device 100 includes a processing unit 110, a display unit 120, a reflective component 130, and at least one temperature sensor 140. For example, in the present embodiment, the processing unit 110 may include one or a plurality of processors. The processor may be, for example, a central processing unit (CPU) or other programmable general-purpose or special-purpose micro control unit (MCU), microprocessor, digital signal processor (DSP), programmable controller, application-specific integrated circuit (ASIC), arithmetic logic unit (ALU), complex programmable logic device (CPLD), field-programmable gate array (FPGA), or other similar elements or a combination of the above elements. In an embodiment, each function of the processing unit 110 may be implemented as a plurality of program codes. These program codes may be stored in a memory, and executed by the processing unit 110. Alternatively, in an embodiment, the functions of the processing unit 110 may be implemented by one or a plurality of circuits. The invention is not limited to a particular implementation, and the processing unit 110 may be implemented by either software or hardware.

As shown in FIG. 1, in the present embodiment, the display unit 120 is configured to provide an image beam IL. The display unit 120 includes a light source module 121 and a light modulation module 122. In the present embodiment, the light modulation module 122 is, for example, a display panel. The light source module 121 is configured to provide an illumination beam (not shown), and the light modulation module 122 is disposed on the transmission path of the illumination beam and configured to convert the illumination beam into the image beam IL. For example, in the present embodiment, the light source module 121 may include one or more light sources, wherein the light source(s) may be implemented as a light-emitting diode (LED), a laser diode (LD), or a combination of the above. In the present embodiment, the light modulation module 122 is, for example, a liquid-crystal panel, a liquid-crystal-on-silicon display panel, an electro-optical modulator, a magneto-optic modulator, or an acousto-optic modulator (AOM). In other embodiments, the light modulation module 122 may be implemented as a digital micro-mirror device (DMD).

As shown in FIG. 1, the image beam IL emitted from the display unit 120 may be reflected to a windshield WS via the reflective component 130, for example. The windshield WS may reflect the image beam IL into the field of view of a viewer V, thereby forming a virtual image in front of the eyes of the viewer V. For example, the viewer V may observe the virtual image formed by the image beam IL, such as an image IM, at a side (for example, outside the vehicle) of the windshield WS opposite to the viewer V. The image IM may include driving information, road condition information, or other types of information, and the embodiments of the invention are not limited thereto.

The reflective component 130 is disposed on the transmission path of the image beam IL and has an open state and a closed state. In the present embodiment, the reflective component 130 includes at least one reflector 131 and at least one driving member 132. The at least one temperature sensor 140 is disposed on the reflective component 130 and configured to sense the reflective component 130 to obtain at least one temperature. In the present embodiment, the at least one reflector 131 includes a plurality of reflectors 131, and the at least one temperature sensor 140 is disposed on the surface of one of the plurality of reflectors 131 facing away from the display unit 120. For example, as shown in FIG. 1, in the present embodiment, the at least one reflector 131 includes a first mirror 131A and a second mirror 131B. The second mirror 131B is located between the first mirror 131A and the display unit 120 on the transmission path of the image beam IL. The at least one temperature sensor 140 is disposed on the first mirror 131A or the second mirror 131B. The at least one temperature sensor 140 may be implemented as a thermal sensor or a thermistor.

The driving member 132 may be, for example, a motor, and is coupled with a plurality of gears, slide rails, or connecting rods (not shown) to mechanically connect at least one of the first mirror 131A and the second mirror 131B, thus controlling the first mirror 131A and/or the second mirror 131B (at least one of the first mirror 131A and the second mirror 131B) to be reciprocated or rotated, so that the movement of the first mirror 131A and/or the second mirror 131B (at least one of the first mirror 131A and the second mirror 131B) may change the transmission direction of the image beam IL to adjust the position of the image IM viewed by the viewer V, or to prevent the image IM from being formed. In an embodiment, the first mirror 131A and the second mirror 131B may be one of a plane mirror, a convex reflector, and a concave reflector respectively. In FIG. 1, one driving member 132 is disposed on the second mirror 131B as an example, the first mirror 131A is a concave reflector, and the second mirror 131B is a plane mirror. In other embodiments, the quantity of the driving member 132 and the first mirror 131A and the second mirror 131B may be adjusted according to actual needs, for example, corresponding driving members 132 are disposed on both the first mirror 131A and the second mirror 131B, or the same driving member 132 is used to control the first mirror 131A and the second mirror 131B at the same time, or the driving member 132 is disposed only on the first mirror 131A, or the driving member 132 is disposed only on the second mirror 131B. In the present embodiment, when the reflective component 130 is in the open state, the first mirror 131A and the second mirror 131B may make the image beam IL form a specific optical path, so that the image beam IL may form a virtual image in front of the eyes of viewer V. When the reflective component 130 is in the closed state, for example, when the driving member 132 changes the rotation angle or the position of the first mirror 131A and/or the second mirror 131B (at least one of the first mirror 131A and the second mirror 131B), the optical path of the image beam IL is changed so that a virtual image may not be formed in front of the eyes of the viewer V.

In the present embodiment, the at least one temperature sensor 140 is a plurality of temperature sensors 140, and the plurality of temperature sensors 140 are disposed on the center region and at the surrounding corners of one of the plurality of reflectors 131 (as shown in FIG. 2, nine temperature sensors 140 are evenly distributed on the back surface of the second mirror 131B). As shown in FIG. 1, when an ambient light SL (for example, sunlight) is incident on the windshield at a specific angle, the ambient light SL is incident on the light modulation module 122 of the display unit 120 along a specific optical path. When the ambient light SL is too bright, for example, when the ambient light SL of the environment of the viewer V or the vehicle is too bright, after passing through the windshield WS, the ambient light SL may be reflected by the first mirror 131A and/or the second mirror 131B (at least one of the first mirror 131A and the second mirror 131B) to (toward) the light modulation module 122 of the display unit 120. The temperature of the light modulation module 122 of the display unit 120 is increased after being continuously exposed to the ambient light SL. When the temperature is increased to exceed the specification of the operating temperature of the light modulation module 122 of the display unit 120, the display unit 120 may shut down, experience component failure, or suffer permanent damage.

Moreover, since the ambient light SL may also be reflected by the plurality of reflectors 131 of the reflective component 130 on the specific optical path where the image beam IL forms the image IM, the at least one temperature sensor 140 may be disposed on one of the plurality of reflectors 131 to measure the temperature change of the reflector 131 of the reflective component 130, so as to determine whether the ambient light SL is incident on the reflector 131 of the reflective component 130. Moreover, since disposing the temperature sensor 140 on the reflective surface of the reflector 131 affects the imaging, the temperature sensor 140 is disposed on the back surface of the reflector 131. Each of the reflectors 131 includes a base material, and the temperature sensor 140 may be disposed on the back side (the side facing away from the light) of the base material. The side of the base material facing the light is coated with a reflective layer or polished to form a mirror surface, thereby forming the reflective surface of each of the reflectors 131. When the plurality of reflectors 131 of the reflective component 130 are exposed to the ambient light SL, the plurality of reflectors 131 of the reflective component 130 absorb a portion of the energy and conduct the resulting heat to the back surfaces thereof. Therefore, the temperature change of the reflectors 131 of the reflective component 130 may be detected by the temperature sensor 140 disposed on the back surfaces of the reflectors 131, and accordingly whether the ambient light SL is incident on the light modulation module 122 of the display unit 120 is determined.

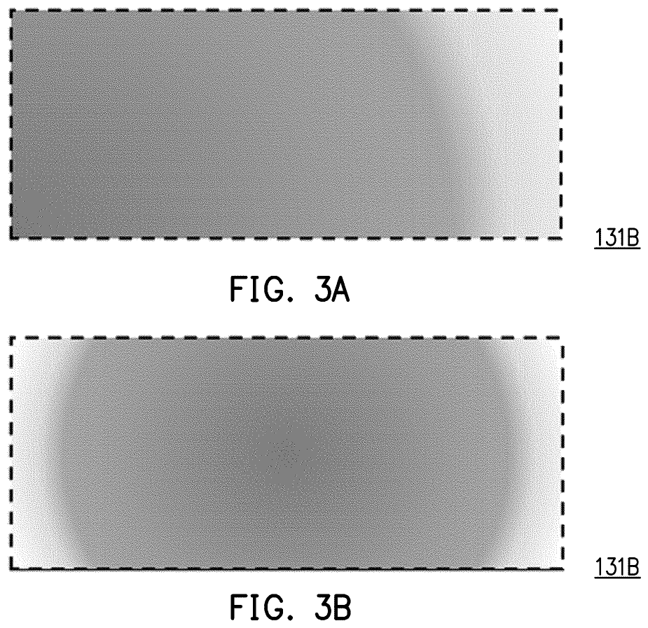

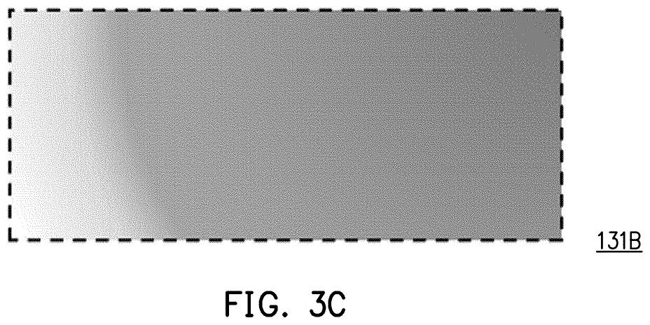

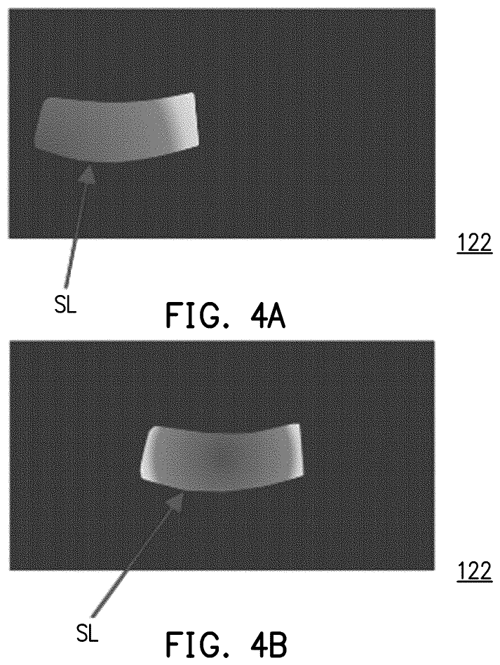

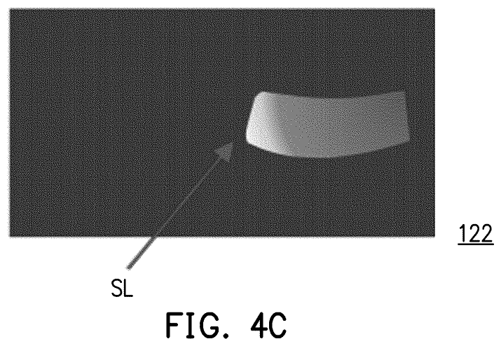

FIG. 3A to FIG. 3C and FIG. 4A to FIG. 4C are respectively schematic top views of the corresponding positions of the light spot distributions formed by the reflective component 130 and the display unit 120 of FIG. 2 after being exposed to the ambient light SL. Furthermore, since the display unit 120 is exposed to the ambient light SL reflected from the reflective component 130, as shown in FIG. 3A to FIG. 3C and FIG. 4A to FIG. 4C, in the present embodiment, the light spot distributions formed after exposure to the ambient light SL have corresponding positional relationships between the reflective component 130 and the display unit 120. There is also a correlation between the temperature changes of the reflective component 130 and the display unit 120 after being exposed to the ambient light SL. Therefore, the current temperature of the display unit 120 may be estimated based on the measured temperature of the reflector 131 of the reflective component 130.

As shown in FIG. 1, in the present embodiment, the head-up display device 100 further includes an ambient temperature sensor 150. The processing unit 110 is electrically connected to the at least one temperature sensor 140 and the ambient temperature sensor 150, and the processing unit 110 is configured to periodically control the at least one temperature sensor 140 to sense and obtain at least one temperature of the at least one temperature sensor 140, and periodically control the ambient temperature sensor 150 to obtain the ambient temperature. Furthermore, in the present embodiment, the processing unit 110 may obtain the first threshold based on the ambient temperature and the reference temperature of the display unit 120, wherein the reference temperature of the display unit 120 is, for example, the stable temperature of the display unit 120 when used for a long time without exposure to sunlight. This stable temperature may be obtained through previous experiments, and relevant numerical records are stored in the processing unit 110. For example, the first threshold may be obtained by multiplying the difference between the current ambient temperature and the reference temperature of the display unit 120 by the temperature dependence (relative heat capacity ratio C) coefficient between the display unit 120 and the reflective component 130 and then adding the value of the ambient temperature. Furthermore, in the present embodiment, a first threshold T₁ may be calculated based on the following Equation 1.

$${T}_{1} = \frac{{T}_{ref} - {T}_{a}}{C} + {T}_{a} \qquad ( Equation 1 )$$

wherein T₁ is the first threshold, T_{ref} is the reference temperature of the display unit 120, Ta is the ambient temperature, C is a parameter representing the temperature correlation between the display unit 120 and the reflective component 130, the physical meaning of C is the relative heat capacity ratio (i.e., C=the heat capacity of the reflective component 130 divided by the heat capacity of the display unit 120). The value of C, representing the temperature dependence between the display unit 120 and the reflective component 130, may be obtained through previous experiments. Relevant numerical records of different product specifications may be stored in the processing unit 110 for use in calculating the first threshold T₁.

In the present embodiment, the processing unit 110 may also obtain (determine) the second threshold based on the ambient temperature and the specification temperature of the display unit 120, wherein the specification temperature of the display unit 120 is the maximum allowable operating temperature of the display unit 120. This specification temperature may also be obtained according to the relevant numerical records of product specifications stored in the processing unit 110. The second threshold may also be calculated by multiplying the difference between the specification temperature of the display unit 120 and the ambient temperature by the temperature dependence coefficient (i.e., the relative heat capacity ratio C, defined as the heat capacity ratio of the reflective component 130 relative to the display unit 120) between the display unit 120 and the reflective component 130, and then adding the value of the ambient temperature. Similarly, in the present embodiment, the second threshold may also be calculated based on the following Equation 2.

$${T}_{2} = \frac{{T}_{spec} - {T}_{a}}{C} + {T}_{a} \qquad ( Equation 2 )$$

wherein T₂ is the second threshold, T_{spec} is the specification temperature of the display unit 120, and the meanings of the other parameters are the same as Equation 1 and are not described again here.

In the present embodiment, since the specification temperature of the display unit 120 is the maximum allowable operating temperature of the display unit 120, the second threshold is greater than the first threshold. The specification temperature of the display unit 120 is, for example, 10° C. higher than the reference temperature of the display unit 120. In an embodiment in which the ambient temperature sensor 150 is not adopted, the first threshold and the second threshold may also be predefined parameters stored in the processing unit 110 or in a storage medium coupled to the processing unit 110. The processing unit 110 may directly read the first threshold and the second threshold without detecting the ambient temperature.

In this way, when the light modulation module 122 is exposed to the ambient light SL resulting in the temperature of the light modulation module 122 being too high, or the light modulation module 122 is overheated due to an increase in ambient temperature, the highest temperature (maximum value) in the plurality of temperatures sensed by the plurality of temperature sensors 140 is greater than the first threshold or the second threshold. At this time, the intensity of the image beam IL may be controlled and reduced via the processing unit 110 to reduce the temperature of the light modulation module 122. The method of reducing the intensity of the image beam IL is, for example, a method such as reducing the driving current, the driving voltage, or the luminous power of the light source module 121 to reduce the intensity of the illumination beam of the light source module 121, thereby reducing the intensity of the image beam IL, and reducing the heat absorbed by the light modulation module 122 to facilitate heat dissipation and cooling of the light modulation module 122.

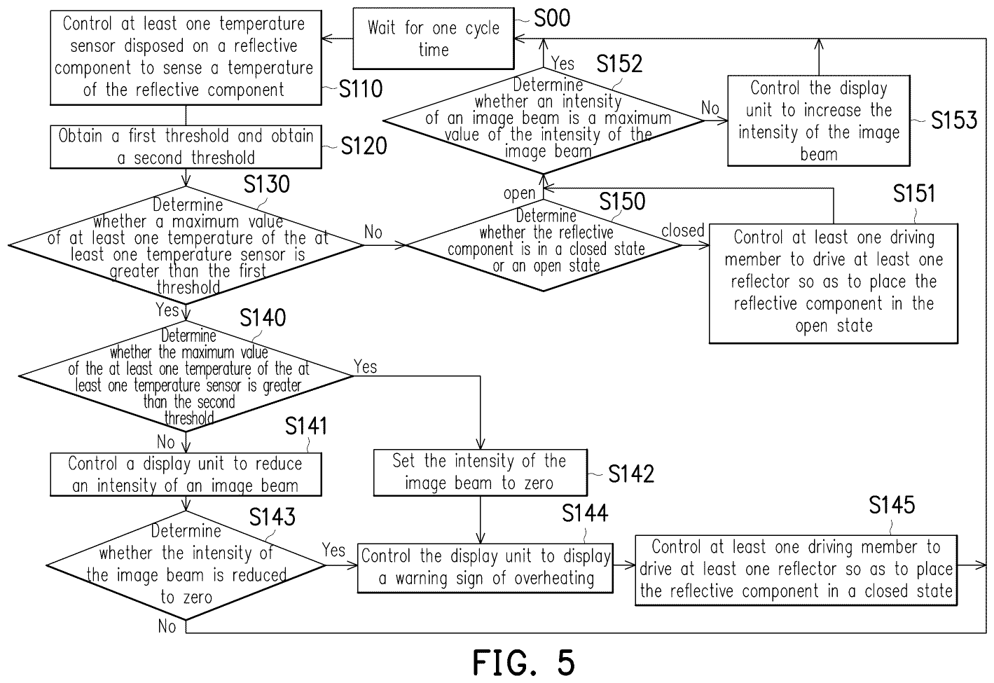

The process steps of the temperature control method of the head-up display device 100 are further explained below with reference to FIG. 5.

FIG. 5 is a schematic flowchart of a temperature control method of the head-up display device 100 of an embodiment of the invention. For example, the head-up display device 100 shown in FIG. 1 and FIG. 2 may be configured to perform the temperature control method of the head-up display device 100 of FIG. 5 to prevent the head-up display device 100 from being damaged by exposure to the ambient light SL, but the invention is not limited thereto. As shown in FIG. 5, in the present embodiment, the processing unit 110 of the head-up display device 100 is electrically connected to the display unit 120, the reflective component 130, the at least one driving member 132, and the at least one temperature sensor 140, and may be used to perform the following steps.

First, as shown in FIG. 5, in the present embodiment, the processing unit 110 performs step S110, in which the processing unit 110 controls the at least one temperature sensor 140 disposed on the reflective component 130 to periodically sense the temperature of the reflective component 130 to obtain the at least one temperature of the at least one temperature sensor 140. Next, the processing unit 110 performs step S120, and the processing unit 110 obtains the first threshold and the second threshold. In step S120, the processing unit 110 may control the ambient temperature sensor 150 to periodically sense the ambient temperature to obtain the ambient temperature, and obtain the first threshold based on the ambient temperature and the reference temperature of the display unit 120, and obtain the second threshold based on the ambient temperature and the specification temperature of the display unit 120. Next, the processing unit 110 performs step S130 to determine whether the maximum value of the at least one temperature of the at least one temperature sensor 140 is greater than the first threshold.

When the maximum value of the at least one temperature is greater than the first threshold, the processing unit 110 performs step S140, in which the processing unit 110 determines whether the maximum value of the at least one temperature of the at least one temperature sensor 140 is greater than the second threshold. When the maximum value of the at least one temperature is greater than the first threshold and less than or equal to the second threshold, the processing unit 110 performs step S141 to control the display unit 120 to reduce the intensity of the image beam IL, wherein the amount of the intensity of the image beam IL reduced by the processing unit 110 each time is 5% to 15% of the maximum value of the intensity of the image beam IL. For example, in the present embodiment, the amount of the intensity of the image beam IL reduced by the processing unit 110 each time is 10% of the maximum value of the intensity of the image beam IL.

Next, the processing unit 110 performs step S143 to determine whether the intensity of the image beam IL is reduced to zero. When the intensity of the image beam IL is not reduced to zero, the processing unit 110 performs step S00, waits for one cycle, and then returns to step S110. When the intensity of the image beam IL has been reduced to zero, the processing unit 110 performs step S144 to control the display unit 120 to display a warning sign of overheating to inform the viewer V, and then, the processing unit 110 performs step S145 to control the at least one driving member 132 to drive the at least one reflector 131 to place the reflective component 130 in the closed state. In the present embodiment, the method of controlling the at least one driving member 132 drive the at least one reflector 131 may be to change the rotation angle or the position of the first mirror 131A and/or the second mirror 131B (at least one of the first mirror 131A and the second mirror 131B). In other embodiments, the driving mode of the at least one driving member 132 controlling the reflective component 130 may also be different depending on the location of the temperature sensor 140. For example, when the temperature sensor 140 is disposed on the second mirror 131B, the at least one driving member 132 may switch between the open state and the closed state of the reflective component 130 by changing the rotation angle or the position of any of the first mirror 131A and the second mirror 131B. When the temperature sensor 140 is disposed on the first mirror 131A, the at least one driving member 132 switches the open state or the closed state of the reflective component 130 only by changing the rotation angle or the position of the first mirror 131A.

Moreover, after step S140 is performed, when the maximum value of the at least one temperature is greater than the second threshold, the processing unit 110 performs step S142 to cause the display unit 120 to set the intensity of the image beam IL to zero, that is, the light source module 121 is turned off, and step S144 is performed to control the display unit 120 to display a warning sign of overheating. Next, the processing unit 110 performs step S145 to control at least one driving member 132 to drive the at least one reflector 131 so as to place the reflective component 130 in the closed state. Next, the processing unit 110 performs step S00 to wait for one cycle, and then returns to step S110.

Moreover, after the processing unit 110 performs step S130, when the maximum value of the at least one temperature is less than or equal to the first threshold, the processing unit 110 performs step S150 to determine whether the reflective component 130 is in the closed state or the open state. When the reflective component 130 is in the closed state, the processing unit 110 performs step S151 to cause the at least one driving member 132 to drive the at least one reflector 131 to place the reflective component 130 in the open state, and then step S152 is performed. When the reflective component 130 is in the open state, the processing unit 110 directly performs step S152 to determine whether the intensity of the image beam IL is the maximum value of the intensity of the image beam IL. The maximum value may correspond to the maximum brightness of the image beam IL that the display unit 120 may provide, or may be the original brightness setting value of the image beam IL.

When the intensity of the image beam IL is not the maximum value of the intensity of the image beam IL, the processing unit 110 performs step S153, in which the display unit 120 is controlled to increase the intensity of the image beam IL via the processing unit 110, wherein the amount of the intensity of the image beam IL increased by the processing unit 110 each time is also between 5% and 15% of the maximum value of the intensity of the image beam IL. For example, in the present embodiment, the amount of the intensity of the image beam IL increased by the processing unit 110 each time is 10% of the maximum value of the intensity of the image beam IL. Next, step S00 is performed, and after waiting for one cycle, step S110 is performed again.

When the intensity of the image beam IL is the maximum value of the intensity of the image beam IL, the processing unit 110 directly performs step S00, waits for one cycle, and then returns to step S110. In the present embodiment, one cycle time (the duration of one cycle) is, for example, 10 seconds to 20 seconds. For example, one cycle time is 15 seconds. In this way, the temperature sensor and the ambient temperature sensor 150 may have sufficient response time to measure a more accurate temperature.

In this way, through the above process, when the maximum value of the at least one temperature is greater than the first threshold, the processing unit 110 is configured to control the display unit 120 to reduce the intensity of the image beam IL and/or to place the reflective component 130 in the closed state (the processing unit 110 is configured to perform at least one of controlling the display unit 120 to reduce the intensity of the image beam IL and placing the reflective component 130 in the closed state). When the maximum value of the at least one temperature is less than or equal to the first threshold, the processing unit 110 is configured to control the display unit 120 to increase the intensity of the image beam IL and/or to place the reflective component 130 in the open state (the processing unit 110 is configured to perform at least one of controlling the display unit 120 to increase the intensity of the image beam IL and placing the reflective component 130 in the open state).

Moreover, in the present embodiment, through the above process, when the maximum value of the at least one temperature is greater than the first threshold and the intensity of the image beam IL is zero (has been reduced to zero), the processing unit 110 is configured to control the at least one driving member 132 to drive the at least one reflector 131 so as to place the reflective component 130 in the closed state. When the maximum value of the at least one temperature is greater than the second threshold, the processing unit 110 is configured to adjust the intensity of the image beam IL to zero, and to control the at least one driving member 132 to drive the at least one reflector 131 so as to place the reflective component 130 in the closed state.

Moreover, when the maximum value of the at least one temperature is less than or equal to the first threshold and the reflective component 130 is in the closed state, the processing unit 110 is configured to place the reflective component 130 in the open state. In the present embodiment, when the maximum value of the at least one temperature is less than or equal to the first threshold, the reflective component 130 is in the open state, and when the intensity of the image beam IL is not the maximum value of the intensity of the image beam IL, the processing unit 110 is configured to control the display unit 120 to increase the intensity of the image beam IL.

As a result, the head-up display device 100 may effectively detect whether the ambient light SL is incident on the display unit 120 via the processing unit 110, which controls the display unit 120, the reflective component 130, and the at least one temperature sensor 140. The processing unit 110 may accordingly adjust the intensity of the image beam IL to prevent the head-up display device 100 from being damaged due to excessive exposure to the ambient light SL.

In step S120 of the above embodiment, an example is given in which the processing unit 110 obtains the ambient temperature via the detection of the ambient temperature sensor 150 and accordingly determines the first threshold and the second threshold based on the algorithm. However, in other embodiments, in step S120, the first threshold and the second threshold may also alternatively be parameters stored in a storage medium or the processing unit 110, and the first threshold and the second threshold may be directly read by the processing unit 110 without detecting the ambient temperature.

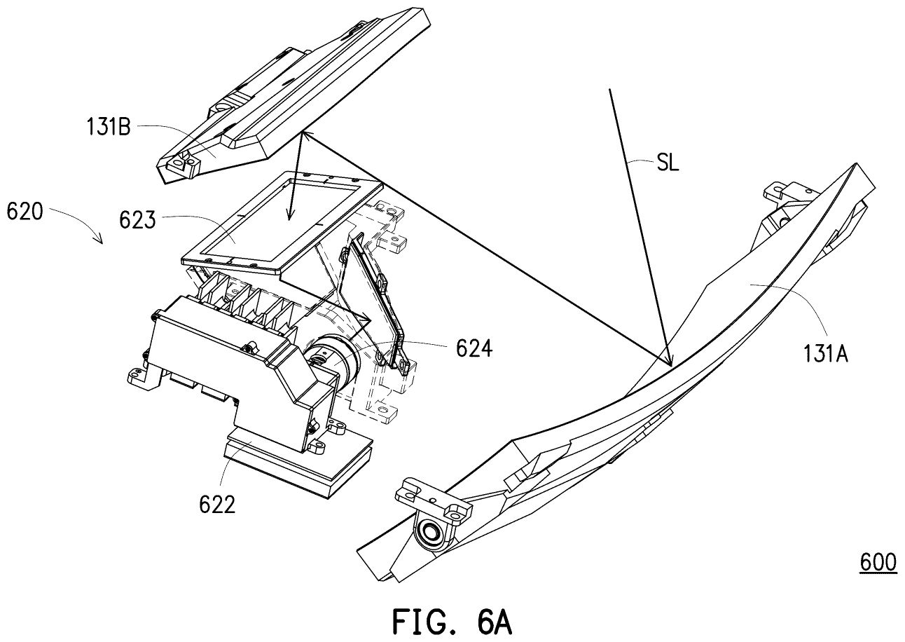

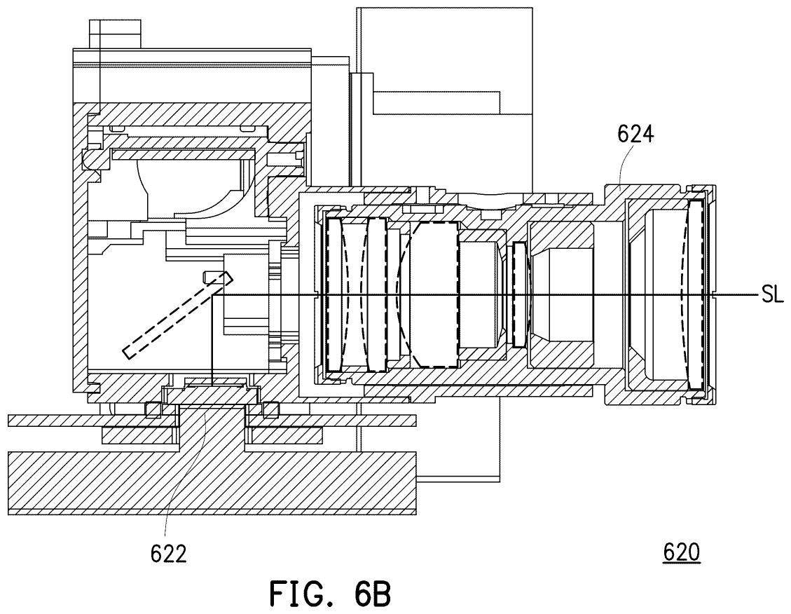

In the above embodiments, the light modulation module 122 of the display unit 120 is exemplified as a display panel. In other embodiments, the light modulation module 122 may be implemented as a digital micro-mirror device (DMD). The head-up display device 100 may also adopt the above-described temperature control method to achieve the above effects and advantages. Further description is provided below with reference to FIG. 6A and FIG. 6B.

FIG. 6A and FIG. 6B are schematic optical path diagrams of another head-up display device of FIG. 1 when exposed to the ambient light SL. A head-up display device 600 of the present embodiment is similar to the head-up display device 100 of FIG. 2, and the differences between the two are as follows. As shown in FIG. 6A and FIG. 6B, in the present embodiment, a light modulation module 622 of a display unit 620 of the head-up display device 600 is a digital micro-mirror device (DMD), and the display unit 620 also includes a diffuser 623 and a lens module 624, the illumination beam of the light source module 121 of the display unit 620 is transmitted to the light modulation module 622 and then converted into the image beam IL, and after being condensed and imaged at the diffuser 623 via the lens module 624, the image beam IL penetrates the diffuser 623 and is transmitted to the reflective component 130. Thus, a virtual image may also be formed in front of the eyes of the viewer V.

Moreover, as shown in FIG. 6A and FIG. 6B, in the present embodiment, since the ambient light SL is incident at a specific angle, the ambient light SL may also be incident on the light modulation module 622 of the display unit 620, and may also be reflected by the first mirror 131A and the second mirror 131B of the reflective component 130. Therefore, the head-up display device 600 may also effectively detect whether the ambient light SL is incident on the display unit 620 via the control of the display unit 620, the reflective component 130, and the at least one temperature sensor 140 by the processing unit 160, so as to perform the temperature control method of the head-up display device shown in FIG. 5 to adjust the intensity of the image beam IL accordingly to prevent the head-up display device 600 from being damaged due to excessive exposure to the ambient light SL and achieve the functions and advantages of the head-up display device 100, which are not described again here.

Based on the above, in the head-up display device and the temperature control method of the head-up display device of an embodiment of the invention, the head-up display device may effectively detect whether the ambient light is incident on the display unit via the control of the display unit, the reflective component, and the at least one temperature sensor by the processing unit and accordingly adjust the intensity of the image beam and/or adjust the state of the reflective component to prevent the head-up display device from being damaged due to excessive exposure to ambient light.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A head-up display device, comprising:
a display unit configured to provide an image beam;
a reflective component disposed on a transmission path of the image beam and having an open state and a closed state;
at least one temperature sensor disposed on the reflective component and configured to sense the reflective component to obtain at least one temperature; and
a processing unit electrically connected to the display unit, the reflective component, and the at least one temperature sensor, and the processing unit is configured to periodically control the at least one temperature sensor to sense and obtain the at least one temperature of the at least one temperature sensor,
wherein when a maximum value of the at least one temperature is greater than a first threshold, the processing unit is configured to control the display unit to reduce an intensity of the image beam and/or to place the reflective component in the closed state,
wherein when the maximum value of the at least one temperature is less than or equal to the first threshold, the processing unit is configured to control the display unit to increase the intensity of the image beam and/or to place the reflective component in the open state.

2. The head-up display device of claim 1, wherein an amount of the intensity of the image beam reduced by the processing unit each time is between 5% and 15% of the maximum value of the intensity of the image beam.

3. The head-up display device of claim 1, further comprising an ambient temperature sensor configured to sense an ambient temperature, wherein the processing unit is electrically connected to the ambient temperature sensor to obtain the ambient temperature, and the processing unit is configured to determine the first threshold based on the ambient temperature and a reference temperature of the display unit.

4. The head-up display device of claim 3, wherein the processing unit is further configured to determine a second threshold based on the ambient temperature and a specification temperature of the display unit, wherein the second threshold is greater than the first threshold.

5. The head-up display device of claim 4, wherein the reflective component comprises at least one reflector and at least one driving member, the at least one driving member is electrically connected to the processing unit, and the at least one driving member is configured to drive the at least one reflector based on a command from the processing unit.

6. The head-up display device of claim 5, wherein when the maximum value of the at least one temperature is greater than the first threshold and the intensity of the image beam is zero, the processing unit is configured to control the at least one driving member to drive the at least one reflector so as to place the reflective component in the closed state.

7. The head-up display device of claim 5, wherein when the maximum value of the at least one temperature is greater than the second threshold, the processing unit is configured to adjust the intensity of the image beam to zero and to control the at least one driving member to drive the at least one reflector so as to place the reflective component in the closed state.

8. The head-up display device of claim 5, wherein the at least one reflector comprises a plurality of reflectors, and the at least one temperature sensor is disposed on a surface of one of the plurality of reflectors, the surface facing away from the display unit.

9. The head-up display device of claim 8, wherein the at least one temperature sensor comprises a plurality of temperature sensors, and the plurality of temperature sensors are disposed on a center region and at surrounding corners of one of the plurality of reflectors.

10. The head-up display device of claim 1, wherein when the maximum value of the at least one temperature is less than or equal to the first threshold and the reflective component is in the closed state, the processing unit is configured to place the reflective component in the open state.

11. The head-up display device of claim 1, wherein when the maximum value of the at least one temperature is less than or equal to the first threshold, the reflective component is in the open state, and the intensity of the image beam is not the maximum value of the intensity of the image beam, the processing unit is configured to control the display unit to increase the intensity of the image beam.

12. A temperature control method of a head-up display device, wherein the head-up display device comprises a display unit, a reflective component, and a processing unit, wherein the display unit is configured to provide an image beam, and the temperature control method of the head-up display device comprises the following steps:
controlling at least one temperature sensor disposed on the reflective component via the processing unit to periodically sense a temperature of the reflective component to obtain at least one temperature of the at least one temperature sensor; and
determining whether a maximum value of the at least one temperature of the at least one temperature sensor is greater than a first threshold via the processing unit, wherein,
when the maximum value of the at least one temperature is greater than the first threshold, the display unit is controlled to reduce an intensity of the image beam and/or to place the reflective component in the closed state,
when the maximum value of the at least one temperature is less than or equal to the first threshold, the display unit is controlled to increase the intensity of the image beam and/or to place the reflective component in the open state.

13. The temperature control method of the head-up display device of claim 12, wherein an amount of the intensity of the image beam reduced each time is 5% to 15% of a maximum value of the intensity of the image beam.

14. The temperature control method of the head-up display device of claim 12, further comprising the following steps:
sensing an ambient temperature via an ambient temperature sensor; and
obtaining the first threshold based on the ambient temperature and a reference temperature of the display unit via the processing unit.

15. The temperature control method of the head-up display device of claim 14, further comprising the following steps:
obtaining a second threshold based on the ambient temperature and a specification temperature of the display unit via the processing unit, wherein the second threshold is greater than the first threshold.

16. The temperature control method of the head-up display device of claim 15, wherein the reflective component comprises at least one reflector and at least one driving member, and the temperature control method of the head-up display device further comprises the following steps:
determining whether the intensity of the image beam is zero via the processing unit when the maximum value of the at least one temperature is greater than the first threshold,
controlling the at least one driving member to drive the at least one reflector so as to place the reflective component in the closed state when the maximum value of the at least one temperature is greater than the first threshold and the intensity of the image beam is zero.

17. The temperature control method of the head-up display device of claim 16, further comprising the following steps:
determining whether the maximum value of the at least one temperature of the at least one temperature sensor is greater than the second threshold via the processing unit, and when the maximum value of the at least one temperature is greater than the second threshold, the intensity of the image beam is adjusted to zero, and the at least one driving member drives the at least one reflector to place the reflective component in the closed state.

18. The temperature control method of the head-up display device of claim 12, further comprising the following steps:
determining whether the reflective component is in the closed state or the open state via the processing unit when the maximum value of the at least one temperature is less than or equal to the first threshold; and
placing the reflective component in the open state via the processing unit when the maximum value of the at least one temperature is less than or equal to the first threshold and the reflective component is in the closed state.

19. The temperature control method of the head-up display device of claim 12, further comprising the following steps:
determining whether the reflective component is in the closed state or the open state via the processing unit when the maximum value of the at least one temperature is less than or equal to the first threshold;
determining whether the intensity of the image beam is the maximum value of the intensity of the image beam when the reflective component is in the open state; and
controlling the display unit to increase the intensity of the image beam via the processing unit when the reflective component is in the open state and the intensity of the image beam is not the maximum value of the intensity of the image beam.
